(19) United States
(12) Patent Application Publication
(10) Pub. No.: US 2004/0111396 A1
(43) Pub. Date: Jun. 10, 2004

(54) Querying against a hierarchical structure such as an extensible markup language document

(76) Inventors: Eldar Musayev, Sammamish, WA (US); Haiyang Hao, Redmond, WA (US); Arpan Desai, Kirkland, WA (US); Chia-Hsun Chen, Redmond, WA (US)

Correspondence Address: WOODCOCK WASHBURN LLP, ONE LIBERTY PLACE, 46TH FLOOR, 1650 MARKET STREET, PHILADELPHIA, PA, 19103, US

(21) Appl. No.: 10/313,907

(22) Filed: Dec. 6, 2002

(51) Int. Cl. G06F 17/30

(52) U.S. Cl. 707/3

(57) ABSTRACT

A method is disclosed for querying a hierarchically structured document embodied in a data stream. A query specifies desired data to be obtained from the document and reference data from which the desired data may be determined by way of reference thereto. The reference data specified in the query is verified to occur in the passing data stream prior to the desired data, and the passing data stream is examined. The reference data in the passing data stream is located and thereafter, and with reference to the located reference data, the desired data in the passing data stream is located and outputted.

### FIELD OF THE INVENTION

This invention relates in general to querying against a hierarchical structure. More particularly, the present invention relates to querying against such a hierarchical structure as embodied within a passing data stream. Even more particularly, the present invention relates to querying against a hierarchical structure such as an eXtensible Markup Language (XML) document.

### BACKGROUND OF THE INVENTION

Electronic data are often formed into hierarchical structures. Handling data in this way enables a programmer to efficiently organize data for use in a variety of applications. For example, in some hierarchical structures, such as structures formed from an eXtensible Markup Language (XML), a programmer is able to define the data is such a way so as to permit a variety of applications to operate on the data. In previous systems, the data needed to be application-specific.

To query data having a hierarchical structure, a computer programmer typically uses a conventional random access technique where the document containing the hierarchically structured data is loaded into a random access memory or the like and then queried. Presently, these queries are performed on hierarchically structured data by first loading the entire document having the data to be queried into memory and then running the query.

However, and significantly, the requirement of loading the entire document into memory takes up significant system resources and slows the actual performance of the query. Such a requirement becomes more onerous as the size of the document is increased. To handle queries on increasingly large documents, a computer system must employ a memory that is large enough to handle the entire document, plus additional memory for processing overhead and other fumctions. Such a memory requirement is especially burdensome if the document to be queried is an especially large database or the like with a size in the order of hundreds of megabytes or even gigabytes. In addition, simply managing the data in memory becomes a more onerous task for the computer system, because so much data must be moved and accounted for. Such a task takes up the computer system's resources and thereby slows the query, as well as any other functions the system is concurrently performing.

In view of the foregoing, there is a need for a system and method that overcomes the limitations and drawbacks set forth above. Namely, what is needed is a method and system of querying a document in a manner that does not require the entire document to be available in memory, and in fact requires as little memory as possible. In particular, there is a need for a system and method of querying a passing data stream that embodies the hierarchical structure.

### SUMMARY OF THE INVENTION

The present invention overcomes these problems by providing a method and system for querying a data stream of the hierarchical data. The hierarchical data can be represented in a data stream that may be examined by a query processor as the stream passes by. The query is carried out in a forward-only manner with regard to the data stream to permit querying of the hierarchical structure therein without the requirement of storing the entire hierarchical structure in memory.

In the method, a hierarchically structured document is received, where the hierarchically structured document is embodied in a data stream such that the embodied hierarchical structure has an order and the data stream has a corresponding order. A query is received, where the query specifies desired data to be obtained from the hierarchically structured document and reference data from which the desired data may be determined by way of reference thereto within the document. The method verifies that the reference data specified in the query will occur in the passing data stream prior to the desired data specified in the query, and then examines the passing data stream embodying the hierarchically structured document. The reference data in the passing data stream is located and thereafter, and with reference to the located reference data, the desired data in the passing data stream is located. Finally, the desired data is outputted.

### BRIEF DESCRIPTION OF THE DRAWINGS

The foregoing summary, as well as the following detailed description of preferred embodiments, is better understood when read in conjunction with the appended drawings. For the purpose of illustrating the invention, there is shown in the drawings exemplary embodiments of the invention; however, the invention is not limited to the specific methods and instrumentalities disclosed. In the drawings:

FIG. 1 is a tree diagram showing an exemplary computing environment in which aspects of the invention may be implemented;

FIG. 2a is a block diagram showing an example of data arranged into a hierarchical structure;

FIG. 2b is a diagram showing an example of the hierarchical structure of FIG. 2a organized into a passing data stream;

FIG. 3 is a block diagram of an exemplary query system employed in connection with the present invention;

FIG. 4 is an example of hierarchically structured data to be queried in connection with the present invention;

FIG. 5 is a diagram of an example of a query structure employed in connection with the present invention; and

FIG. 6 is a flowchart illustrating querying of hierarchically structured data such as that shown in FIG. 4 in accordance with one embodiment of the present invention.

### DETAILED DESCRIPTION OF PREFERRED EMBODIMENTS

Overview

The present invention is directed to systems and methods for querying a representation of hierarchical data in a data stream. The present invention can be implemented to query any electronic document having a hierarchical structure. Computer languages such as XML and Standard Generalized Markup Language (SGML) exhibit a structure suitable for use with the present invention, but other languages using some type of hierarchical structure are compatible as well.

The present invention improves the ability of a computer system to handle queries of hierarchically structured documents, particularly large hierarchically structured documents. Conventionally, when a document containing hierarchically structured data is queried, a computer system must first load the entire document into memory. This becomes burdensome as the size of the document being queried increases. The present invention allows the hierarchically structured data to be presented to the computer system in the form of a stream, so that only a small portion of the document is required to be available to the computer system at any given time during the query. The hierarchical structure of the data in the document is represented in the data stream so that the computer system may be aware of the hierarchical structure of the data as the data passes by.

The present invention provides a user with an ability to perform forward-only queries that require a minimum of memory. A query structure is provided that permits a forward-only query, and the grammar of an exemplary structured language is modified to effectuate forward-only querying.

Exemplary Computing Environment

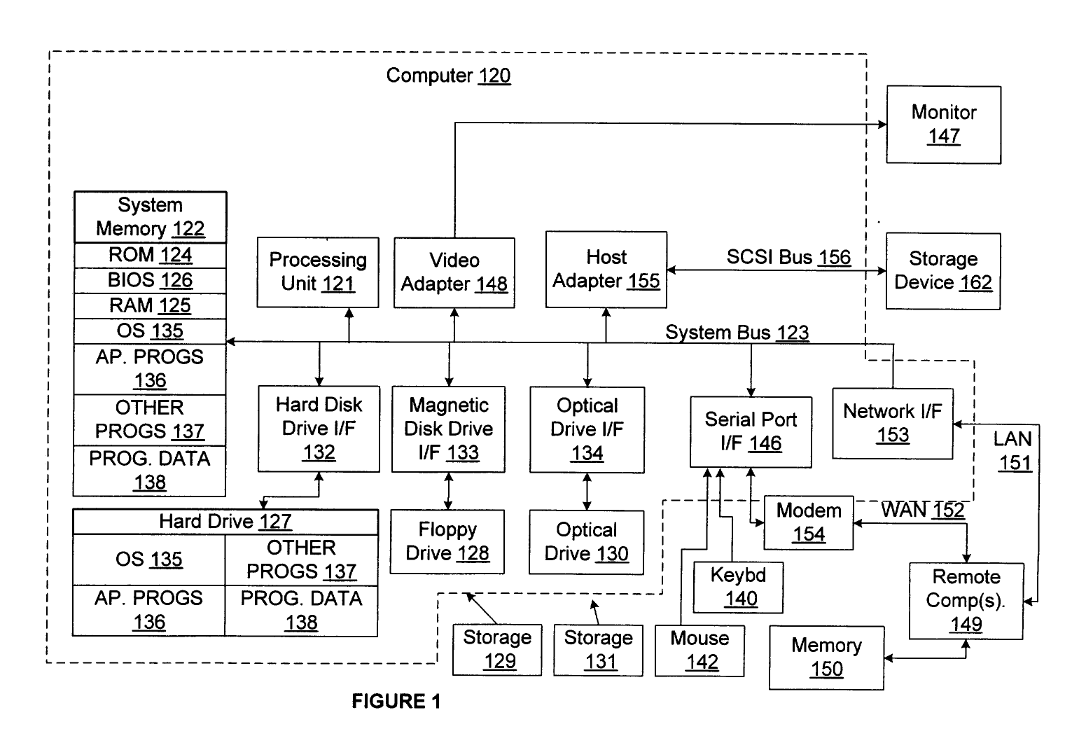

FIG. 1 illustrates an example of a suitable computing system environment 100 in which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network or other data transmission medium. In a distributed computing environment, program modules and other data may be located in both local and remote computer storage media including memory storage devices.

With reference to FIG. 1, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

Computer 110 typically includes a variety of computer readable media. Computer readable media can be any available media that can be accessed by computer 110 and includes both volatile and non-volatile media, removable and non-removable media. By way of example, and not limitation, computer readable media may comprise computer storage media and communication media. Computer storage media includes both volatile and non-volatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or non-volatile memory such as ROM 131 and RAM 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/non-volatile computer storage media. By way of example only, FIG. 1 illustrates a hard disk drive 140 that reads from or writes to non-removable, non-volatile magnetic media, a magnetic disk drive 151 that reads from or writes to a removable, nonvolatile magnetic disk 152, and an optical disk drive 155 that reads from or writes to a removable, non-volatile optical disk 156, such as a CD-ROM or other optical media. Other removable/non-removable, volatile/non-volatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media, discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

Exemplary Distributed Computing Frameworks Or Architectures

Various distributed computing frameworks have been and are being developed in light of the convergence of personal computing and the Internet. Individuals and business users alike are provided with a seamlessly interoperable and web-enabled interface for applications and computing devices, making computing activities increasingly web browser or network-oriented.

For example, MICROSOFT®'s .NET platform includes servers, building-block services, such as web-based data storage, and downloadable device software. Generally speaking, the .NET platform provides (1) the ability to make the entire range of computing devices work together and to have user information automatically updated and synchronized on all of them, (2) increased interactive capability for web sites, enabled by greater use of XML rather than HTML, (3) online services that feature customized access and delivery of products and services to the user from a central starting point for the management of various applications, such as e-mail, for example, or software, such as Office .NET, (4) centralized data storage, which will increase efficiency and ease of access to information, as well as synchronization of information among users and devices, (5) the ability to integrate various communications media, such as e-mail, faxes, and telephones, (6) for developers, the ability to create reusable modules, thereby increasing productivity and reducing the number of programming errors, and (7) many other cross-platform integration features as well.

While exemplary embodiments herein are described in connection with software residing on a computing device, one or more portions of the invention may also be implemented via an operating system, API, or a “middle man” object between a coprocessor and requesting object, such that services may be performed by, supported in, or accessed via all of .NET's languages and services, and in other distributed computing frameworks as well.

Exemplary Embodiments

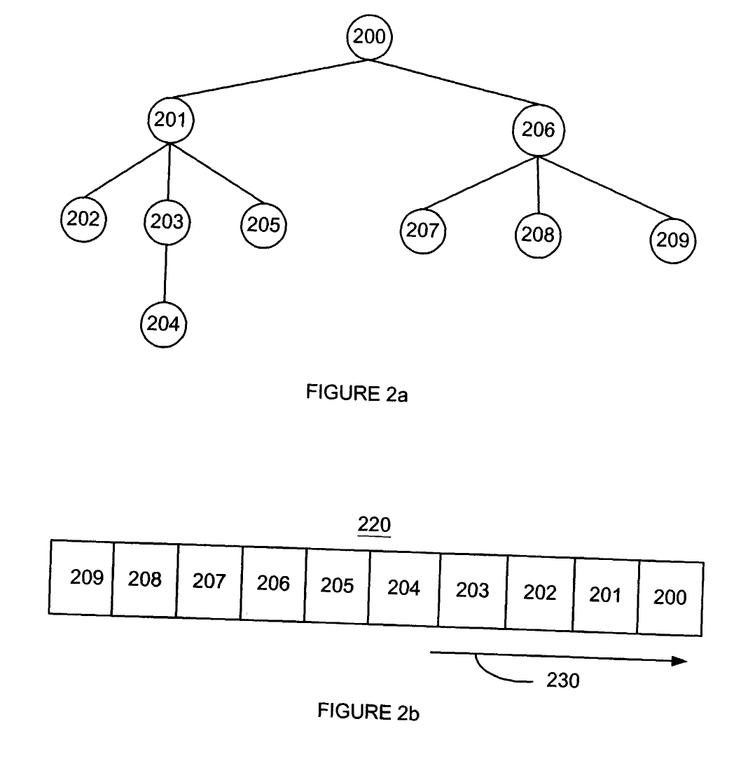

FIG. 2a is a tree diagram showing an example of hierarchically structured data, wherein each piece of data is represented as a node. A high-level or “root” node 200 is shown at the top of the hierarchy, with child nodes 201 and 206. Child node 201 has three child nodes, 202, 203, and 205. Child node 203 has one child node 204. Child node 206 has child nodes 207, 208, and 209. Each of the nodes 200-209 represents a section of data within a corresponding hierarchically structured document. For example, the high-level node 200 may refer to a top-level classification (such as “List”), while the sub-nodes 201 and 206 may refer to a next-level classification (such as “Customer”).

FIG. 2b is an exemplary representation of the hierarchically structured data of FIG. 2a as embodied in a data stream 220. As seen, the nodes 200-209 of FIG. 2a are arranged in a linear fashion to facilitate being streamed past a query processor 301 in the direction of arrow 230. As is conventional, the nodes 200-209 are ordered within the data stream 220 such that the root node 200 is first and the child notes 201-209 follow. In particular, and as is also conventional, for each node 200-209, all child nodes thereof are placed within the data stream 220 after the node and before any next sibling node of the node. Sibling nodes may appear within the data stream 220 in any order, although for the sake of clarity the sibling nodes in FIG. 2a appear in the data stream 220 of FIG. 2b in left-to-right order. Thus, and with regard to sibling nodes 202, 203 and 205, node 203 follows node 202, and node 205 follows node 203, but node 204 as the child node of node 203 appears after node 203 and before node 205. In this way, the query processor 301 will see the root node 200 first, then child node 201, then all of child node 201's descendents 202-205, and then will see child node 201's sibling node 206, and so on. As a result, query processor 301 can discern the hierarchical structure of the data as shown in FIG. 2a from the data stream 220 of FIG. 2b.

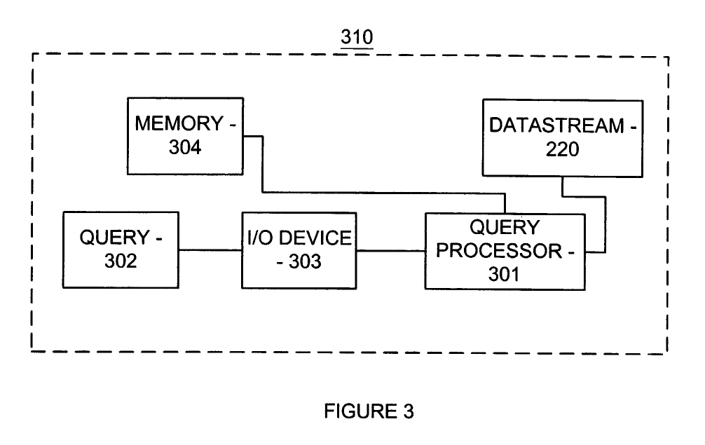

FIG. 3 is an exemplary query system that may be employed in connection with the present invention. Within a computer system 310 a data stream 220 is presented to a query processor 301 in response to a query 302 that is passed to the query processor 301 by way of an input/output (I/O) device 303. The query 302 may be input by a user via the I/O device 303, or may be submitted by another process running on the computer system 310 or another entity in operable connection with the computer system 310. The I/O device 303 may be any method of communicating with the computer system 310 such as, but not limited to, a keyboard, mouse, or disk drive, or any combination thereof. A memory 304, is operably connected to the query processor 301 to store data as is necessary. The query processor 301 is adapted to apply the query 302 to the data stream 220 in a streaming manner, and is operably connected to the memory 304 and the I/O device 303. Significantly, the computer system 310 and query processor 301 may be any appropriate computer system and query processor without departing from the spirit and scope of the present invention. For example, the computer system 310 may be a general purpose personal computer or may be a highly involved query processing system specifically designed to run queries against data. Details of operation of such computer systems 310 and query processors 301 are known or should be apparent and therefore need not be described herein in any detail other than that which is already provided.

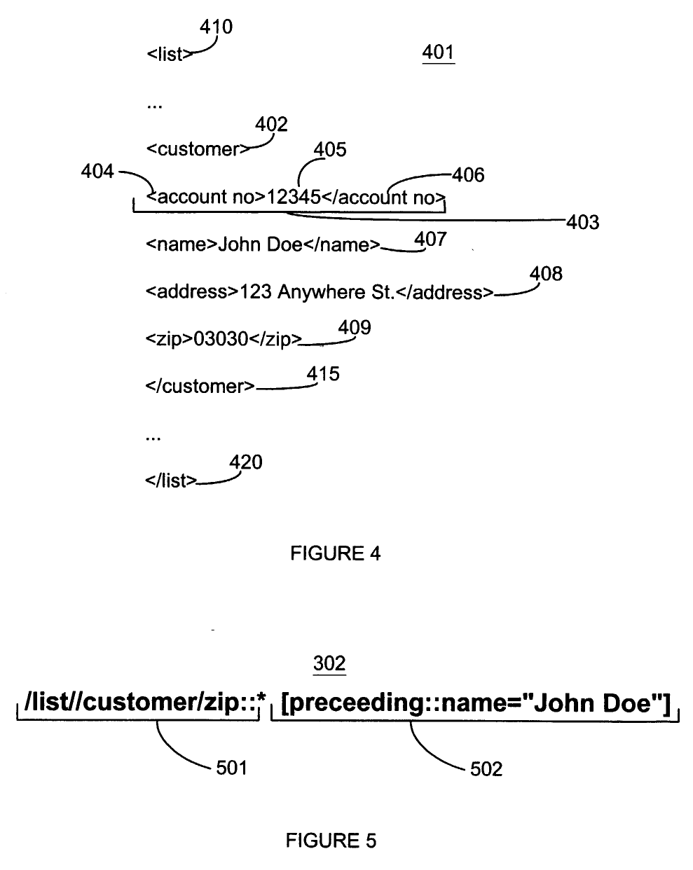

FIG. 4 is an example of a portion of hierarchically structured data 401 in an XML-type format. While this example resembles XML, the present invention is in no way limited to such a language. In fact, the present invention is equally applicable to any form of hierarchically structured data. Within the structured data 401 are different example entries. Entry 410 is a start tag nested under entry 401 and indicates that the structured data 401 corresponds to a list. Entry 402 is a start tag indicating that this portion of the structured data 401 corresponds to a customer. Entry 403 is an account number entry. Entry 403 is nested under entry 402 and comprises a start tag 404, content 405, and an end tag 406. The entries 407-409 that follow are also nested under entry 402 and also comprise structures corresponding to structures 404-406. Entry 407 is a customer name, entry 408 is a customer address, and entry 409 is a customer ZIP code. Entry 415 is an end tag corresponding to entry 402 indicating that this particular customer portion of the structured data 401 has ended, and entry 420 is another end tag corresponding to entry 410 and indicating that this list portion of the structured data 401 has ended. The structured data 401 is an example only, and typically will be much greater in size than what is shown in FIG. 4. However, the present invention will also operate with structured data 401 that is smaller in size than that shown in FIG. 4.

FIG. 5 is an example of a query 302 that may be submitted to the present invention. The query 302 comprises a location path 501 and a predicate 502. The location path 501 specifies a location within the hierarchically structured data 401 of FIG. 4 that which the desired data (the object of the query 302) should be found, while the predicate 502 specifies reference data and also specifies a relationship between the reference data and the desired data. For example, if the desired data is a “zip” entry and the reference data is “John Doe” as a name entry preceding the zip entry, the query 302 may resemble: /list/customer/zip[preceding::name=“John Doe”], where the location path 501 is /list/customer/zip, and the predicate 502 is [preceding::name=“John Doe”]. Such a query may be specified using an XPath-type query. XPath is a language for document addressing in an XML document. XPath performs document addressing by using path notation for navigating through the hierarchical structure of an XML document. However, the present invention is in no way limited to such a format and, in fact, the present invention is equally applicable to any query format.

Conventionally, a query may be characterized as either a forward or reverse query. A forward query specifies the desired data in terms of reference data that precedes the desired data in the queried document, such as when a query requests child data that follows specified parent data, as shown in the example described above with reference to FIG. 5. In a forward query the computer system 310 processes the document until the specified data is found, and then the computer system 310 finds the desired data in a following portion of the document as specified in the location path 501. In contrast to a forward query, a reverse query specifies the desired data in terms of reference data that follows such desired data in the queried document, such as for example when a query requests parent data in terms of a specified child or other descendant. Using the same entries as in the query example discussed above in connection with FIG. 5, a reverse query may resemble: /list/customer/name[following::zip=“03030”], where the desired data specified in the location path 501 is the customer name of entry 407 and the reference data shown in the predicate 502 is the zip of entry 409. In a reverse query the computer system 310 processes the document until the specified data is found, and then the computer system 310 finds the desired data in a preceding portion of the document as specified in the location path 501.

To process a reverse query on a passing data stream 220, a query processor 301, or another processor of the computer system 310 must store some unspecified prior part of the passing data stream 220 in memory 304 so that the query processor 301 may be able to refer back to find the desired data upon reaching the reference data. However and as should be appreciated, the prior art of the passing data stream that should be stored likely cannot be known with any certainty. Accordingly, a reverse query typically requires the storing in memory 304 of a great deal, if not all, of the passing data stream 220 because the query processor 301 is not aware of the location of the desired data until the query processor 301 has encountered the reference data. Therefore, a reverse query requires that the query processor 301 be able to access any part of the data stream 220 that the query processor 301 has already seen. Accordingly, a reverse query being processed in a passing data stream 220 in effect could require that the entire passing data stream 220 be stored in memory 304. As was discussed above, though, the document as embodied by the data stream 220 may be gigantic, perhaps on the order of hundreds of megabytes or even gigabytes. It may be impractical and difficult, if not impossible, then, to store such a gigantic data stream 220. Having a memory 304 large enough to store very large documents also places a burden on other components of the computer system 310, such as the query processor 301 and I/O device 303, that are required to process and transfer large documents into and out of memory 304. As a result, the costs involved with manufacturing, deploying, programming and using a query processor 301 capable of storing a document in memory 304 in accordance with the requirements imposed by a reverse query, as discussed herein, are considerable.

In contrast, processing a forward query does not require that the query processor 30 store very much, if any, of the document or passing data stream 220. In particular, and as was discussed above, in a forward query, the reference data is found first in the passing data stream 220 and then the desired data is found. Accordingly, the query processor 301 need only set a flag or the like indicating that the reference data has been encountered. Then, the query processor 301 waits for the desired data to be encountered in the passing data stream 220 and then the query processor 301 retrieves such desired data as the solution to the query 302. Thus, in an embodiment of the present invention, where a query processor 301 is processing a query 302 against a passing data stream 220, the query 302 is limited to a forward query only.

In an embodiment of the present invention, the query processor 301 verifies that the format of the query 302 conforms to the forward-only convention specified above before attempting to run the query 302 on the passing data stream 220. In the event that the present invention is applied to a computer language having the ability to carry out a reverse query 302, an embodiment of the present invention employs a modified version of the language with a grammar that ensures that only a forward query is submitted to the query processor 301. Note that for a query 302 to be a forward query, the location path 501 of the query 302 must look forward in the passing data stream 220 to, for example, a child, descendant, following sibling, or other following entry. The predicate 502, however, must look backwards in the passing data stream 220 to, for example, a parent, ancestor, preceding sibling, or other preceding entry. Thus, the query processor 301 when processing a forward query 302 sees the reference data in the passing data stream 220 first, then sees the desired data in such passing data strem 220.

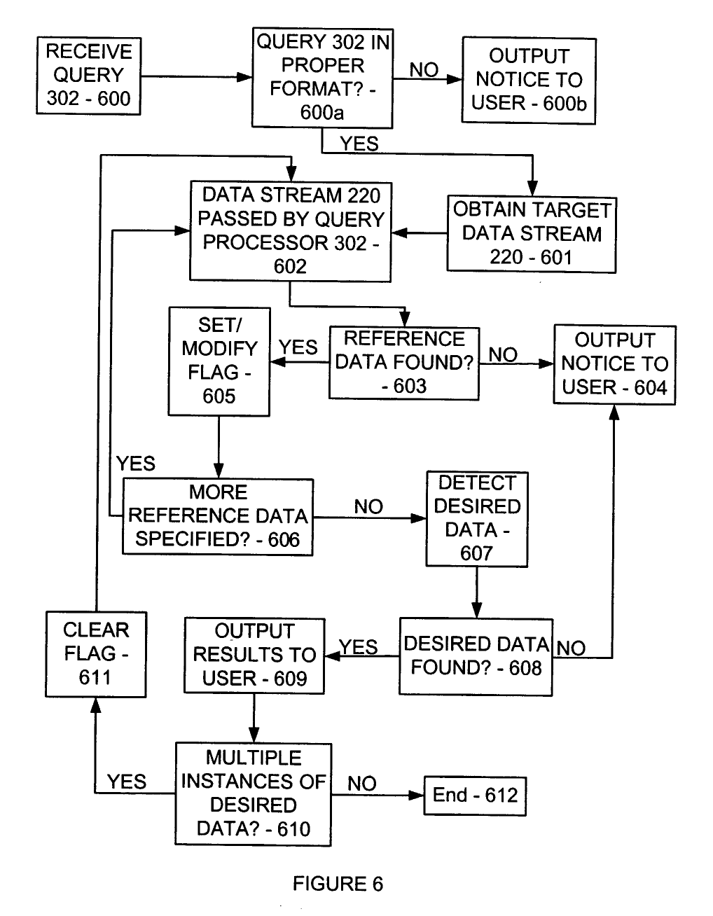

An embodiment of the present invention may be described with reference to FIG. 6, which is a flowchart of a method of querying a data stream 220 in accordance with the present invention. At step 600, a query 302 to be applied against a hierarchical document is received by the computer system 310 via the I/O device 303 thereof. At optional step 600a, the query processor 301 or another processor in the computer system 310 verifies that the query 302 is a forward query and thus is structured in accordance with the requirements discussed above with regard to both the path 501 and the predicate 502. If the query 302 is not structured properly, the query processor 301 or other processor may proceed to optional step 600b and may either issue an error to the user, and/or may prompt the user to enter a properly structured query 302.

At step 601, a query processor 301, such as a general computer processor or a specialized processor, acquires a data stream 220 to be queried where the acquired data stream 220 embodies the document to be queried. Acquiring such data stream 220 may be performed in any appropriate manner without departing from the spirit and scope of the present invention. Typically, such acquiring is achieved by way of an appropriate I/O command to the computer system 310. At step 602 the data stream 220 is passed by the query processor 301 in the manner described above with reference to FIG. 2, and the query processor 301 thus reads the data stream 220 as it passes by. As should be appreciated, the query processor 301 may read the passing data stream 220 in any appropriate manner without departing from the spirit and scope of the present invention. Typically, in reading the data stream 220, the query processor is discerning at least a portion of the tree structure of the hierarchical document embodied within the data stream 220. Thus, the query processor 301, in reading the data stream 220, looks to find the reference data as specified by the predicate 502 of the query 302. For example, if the query 302 is as specified in FIG. 5 and the document as embodied in the data stream 220 corresponds to the data 401 in FIG. 4, the query processor in reading the passing data stream 220 looks to find “John Doe” as a name. At step 603, the query processor 301 determines whether it has encountered the reference data as specified in the predicate 502 of the query 302. If the query processor 301 has processed the entire passing data stream 220 and has not found such reference data, the query processor 301 may proceed to step 604 and may issue an error to the user, prompt the user to enter another query 302 or may display details of the query 302 to the user.

Upon the query processor 301 encountering the reference data, the query processor 301 may set a flag or the like, as indicated by step 605. In the aforementioned example, this would take place when the query processor 301 encounters the customer name of “John Doe.” The flag represents an indicator to the query processor 301 that a specified term in the predicate 502 (“John Doe” of entry 407) has been encountered.

In step 606, the query processor checks the predicate 502 to determine whether the reference data includes more information. For example, if more information is specified in the predicate 502 (for example, if the object of the query 302 is to find the zip at entry 409 of customer “John Doe” of entry 407 who has account number “12345” of entry 403), the query processor 301 continues to read the passing data stream 220 as in step 602. As the query processor 301 continues to find the additional information as specified by the predicate 502, the query processor 301 may set a flag for each additional piece of information encountered or, alternatively, may modify the set flag to indicate the plurality of pieces of information encountered. The flag need not contain any information about either the information encountered or the predicate 502, other than to indicate that the specified information has been encountered.

When all of the information specified in the predicate 502 has been encountered in the passing data stream 220, as indicated by the set flag or flags, the query processor 301 proceeds to step 607 and continues to read the passing data stream 220 until the entry specified in the location path 501 of the query 302 is located. (Again, as in the example of FIG. 5, this would occur when the query processor encounters the zip entry 409.) At step 608, the query processor 301 determines whether the entry specified in the location path 501 of the query 302 has been located. If the query processor has not located the entry specified in the location path 501, the query processor 301 may proceed to step 604 and may issue an error to the user, prompt the user to enter another query 302, issue a report, may display details of the query 302 to the user or the like. If the query processor 301 has located the entry specified in the location path 501, the query processor 301 proceeds to step 609. At such step 609, the query processor 301 obtains the data within one or more located entries (e.g., zip “03030” of entry 409) and outputs such obtained data as the desired data to the user or entity. The processor then proceeds to step 610, at which step the query processor 301 determines if the query 302 possibly specifies multiple instances of the desired data (e.g., the query specifies desired data of a zip for every name “John Doe”). If the query 302 can possibly specify multiple instances of desired data, the query processor 301 proceeds to step 611, at which step the query processor 301 clears the flag in memory 304 and returns to step 602, at which step the data stream 220 continues to pass by the query processor 301 and the query processor 301 attempts to locate any possible next reference data. If the query 302 does not specify multiple instances of desired data, or if all instances of multiple data have been located, processing ends at step 612.

As should be evident from the foregoing discussion, the query processor 301 only needs to look at the passing data stream 220 once assuming the query 302 being processed is a forward query. Because the present invention permits only a forward query 302, the desired data will always occur after the reference data in the passing data stream 220, if the desired data occurs at all. Accordingly, the present invention obviates any need to play back the data stream 220 because the query processor 301 will not return to data in the passing data stream 220 that it has already seen. Therefore, the present invention eliminates any need for the computer system 310 to have a memory 304 capable of storing the entire document that the data stream 220 embodies. Because such document need not be stored in its entirety, the size of the document is not particularly relevant. While a query 302 performed on a larger document may take longer to process than a query 302 performed on a smaller document, the document may be queried by the computer system 310 with minimal memory 304 according to the present invention. Note that any necessary programming for a query processor 301 and computer system 310 in accordance with the present invention should be known or apparent to one skilled in the art, and therefore is not set forth above.

In conclusion, a system and method is disclosed for querying a hierarchically structured document in a manner that does not require the entire document to be available in memory 304. The query 302 is provided as a forward query that specifies desired data in terms of preceding reference data, thereby enabling a query processor 301 to process the query 302 against a passing data stream 220 that embodies the document, without the necessity for returning to previously-viewed portions of the data stream 220. As a result, the data stream 220 and the document need not be stored in memory 304. Accordingly, the present invention discloses a system and method of querying a passing data stream 220 that embodies a hierarchically structured document.

While the present invention has been described in connection with the preferred embodiments of the various figures, it is to be understood that other similar embodiments may be used or modifications and additions may be made to the described embodiment for performing the same function of the present invention without deviating therefrom. For example, one skilled in the art will recognize that the present invention as described in the present application may apply to any computing device or environment, whether wired or wireless, and may be applied to any number of such computing devices connected via a communications network, and interacting across the network. Furthermore, it should be emphasized that a variety of computer platforms, including handheld device operating systems and other application specific operating systems are contemplated, especially as the number of wireless networked devices continues to proliferate. Still further, the present invention may be implemented in or across a plurality of processing chips or devices, and storage may similarly be affected across a plurality of devices. Therefore, the present invention should not be limited to any single embodiment, but rather should be construed in breadth and scope in accordance with the appended claims.

We claim:

1. A method of querying a passing data stream embodying a hierarchically structured document therein in a predetermined manner, comprising:
receiving a query specifying desired data to be obtained from the hierarchically structured document and reference data from which the desired data may be determined by way of reference thereto within the document;
examining the passing data stream embodying the hierarchically structured document;
locating the reference data in the passing data stream;
locating the desired data in the passing data stream after locating the reference data and with reference to the located reference data; and
outputting the desired data.

2. The method of claim 1 further comprising examining the passing data stream continuously from a beginning thereof, the beginning of the passing data stream corresponding to a root level of the hierarchically structured document.

3. The method of claim 1 further comprising verifying that the reference data specified in the query will occur in the passing data stream prior to the desired data specified in the query.

4. The method of claim 1 further comprising setting a flag upon locating the reference data in the passing data stream.

5. The method of claim 4 further comprising clearing the flag upon locating the desired data in the passing data stream.

6. The method of claim 1 further comprising receiving the passing data stream with the hierarchically structured document embodied therein in the predetermined manner.

7. The method of claim 6 further comprising receiving the passing data stream with the hierarchically structured document embodied therein such that an order of elements within the passing data stream corresponds to an order of elements within the hierarchically structured document.

8. The method of claim 7 wherein the hierarchically structured document has a plurality of nodes including a root node and descendant nodes descending therefrom, each descendant node being a child node of a parent node, multiple child nodes of any parent node being sibling nodes of each other and being ordered in a predetermined manner in the passing data stream, and wherein a child node of a parent node appears in the passing data stream after the parent node and before any next sibling node of the parent node.

9. The method of claim 1 wherein the hierarchically structured document is an XML document.

10. The method of claim 1 wherein the hierarchically structured document is a SGML document.

11. The method of claim 1 wherein the query is a XPath-type query.

12. A method of querying a passing data stream, comprising:
receiving a hierarchically structured document;
embodying the hierarchically structured document in a data stream, wherein the embodied hierarchical structure has an order and the data stream has a corresponding order;
receiving a query specifying desired data to be obtained from the hierarchically structured document and reference data from which the desired data may be determined by way of reference thereto within the document;
verifying that the reference data specified in the query will occur in the passing data stream prior to the desired data specified in the query;
examining the passing data stream embodying the hierarchically structured document;
locating the reference data in the passing data stream;
locating the desired data in the passing data stream after locating the reference data and with reference to the located reference data; and
outputting the desired data.

13. The method of claim 12 wherein the hierarchically structured document is an XML document.

14. The method of claim 12 wherein the hierarchically structured document is a SGML document.

15. The method of claim 12 wherein the query is an XPath-type query.

16. A processor for querying a passing data stream embodying a hierarchically structured document therein in a predetermined manner, the processor receiving a query specifying desired data to be obtained from the hierarchically structured document and reference data from which the desired data may be determined by way of reference thereto within the document, the processor examining the passing data stream, locating the reference data in the passing data stream, locating the desired data in the passing data stream after locating the reference data and with reference to the located reference data, and outputting the desired data.

17. The processor of claim 16 wherein the processor verifies that the reference data specified in the query will occur in the passing data stream prior to the desired data specified in the query.

18. The processor of claim 16 wherein the processor sets a flag upon locating the reference data in the passing data stream.

19. The processor of claim 16 wherein the hierarchically structured document is an XML document, and the query is an XPath query.

20. A computer-readable medium having computer-executable instructions for performing a method of querying a passing data stream embodying a hierarchically structured document therein in a predetermined manner, the method comprising:
receiving a query specifying desired data to be obtained from the hierarchically structured document and reference data from which the desired data may be determined by way of reference thereto within the document;
examining the passing data stream embodying the hierarchically structured document;
locating the reference data in the passing data stream;
locating the desired data in the passing data stream after locating the reference data and with reference to the located reference data; and
outputting the desired data.

21. The computer-readable medium of claim 20 wherein the method further comprises examining the passing data stream continuously from a beginning thereof, the beginning of the passing data stream corresponding to a root level of the hierarchically structured document.

22. The computer-readable medium of claim 20 wherein the method further comprises verifying that the reference data specified in the query will occur in the passing data stream prior to the desired data specified in the query.

23. The computer-readable medium of claim 20 wherein the method further comprises setting a flag upon locating the reference data in the passing data stream.

24. The computer-readable medium of claim 23 wherein the method further comprises clearing the flag upon locating the desired data in the passing data stream.

25. The computer-readable medium of claim 20 wherein the method further comprises receiving the passing data stream with the hierarchically structured document embodied therein in the predetermined manner.

26. The computer-readable medium of claim 25 wherein the method further comprises receiving the passing data stream with the hierarchically structured document embodied therein such that an order of elements within the passing data stream corresponds to an order of elements within the hierarchically structured document.

27. The computer-readable medium of claim 26 wherein the hierarchically structured document has a plurality of nodes including a root node and descendant nodes descending therefrom, each descendent node being a child node of a parent node, multiple child nodes of any parent node being sibling nodes of each other and being ordered in a predetermined manner in the passing data stream, and wherein a child node of a parent node appears in the passing data stream after the parent node and before any next sibling node of the parent node.

28. The computer-readable medium of claim 20 wherein the hierarchically structured document is an XML document.

29. The computer-readable medium of claim 20 wherein the hierarchically structured document is a SGML document.

30. The computer-readable medium of claim 20 wherein the query is an XPath-type query.

31. A method for querying a hierarchically structured document in combination with a system that receives a passing data stream embodying the hierarchically structured document in a predetermined manner, the method comprising:
specifying a forward query according to a command set that supports executing only such forward query, the forward query setting forth desired data to be obtained from the hierarchically structured document and reference data from which the desired data may be determined by way of reference thereto within the document, the desired data of the forward query appearing in the passing data stream after the reference data of the forward query;
submitting the forward query to the system, whereby the system examines the passing data stream embodying the hierarchically structured document, locates the reference data in the passing data stream, locates the desired data in the passing data stream and with reference to the located reference data, and outputs the desired data; and
receiving the desired data.

32. The method of claim 31 wherein the hierarchically structured document is an XML document.

33. The method of claim 31 wherein the hierarchically structured document is a SGML document.

34. The method of claim 31 wherein the forward query is an XPath-type query.

35. A computer-readable medium having computer-executable instructions for performing a method for querying a hierarchically structured document in combination with a system that receives a passing data stream embodying the hierarchically structured document in a predetermined manner, the method comprising:
specifying a forward query according to a command set that supports executing only such forward query, the forward query setting forth desired data to be obtained from the hierarchically structured document and reference data from which the desired data may be determined by way of reference thereto within the document, the desired data of the forward query appearing in the passing data stream after the reference data of the forward query;
submitting the forward query to the system, whereby the system examines the passing data stream embodying the hierarchically structured document, locates the reference data in the passing data stream, locates the desired data in the passing data stream and with reference to the located reference data, and outputs the desired data; and
receiving the desired data.

36. The computer-readable medium of claim 35 wherein the hierarchically structured document is an XML document.

37. The computer-readable medium of claim 35 wherein the hierarchically structured document is a SGML document.

38. The computer-readable medium of claim 35 wherein the forward query is an XPath-type query.
